(19) United States
(12) Patent Application Publication
(10) Pub. No.: US 2026/0056792 A1
(43) Pub. Date: Feb. 26, 2026

(54) MANAGING COMPUTER RESOURCE USE WHEN CONDUCTING COMPUTER-IMPLEMENTED RISK ASSESSMENT

(71) Applicant: Royal Bank of Canada, Toronto (CA)

(72) Inventors: Lauren McCabe, Oakville (CA); Sai Krishna Manthena, Burnaby (CA); Nicholas Lam, Toronto (CA); Owen Gretzinger, Oakville (CA); Chai Lam, Toronto (CA); Rosemary Sutton, Mississauga (CA)

(21) Appl. No.: 19/304,217

(22) Filed: Aug. 19, 2025

Related U.S. Application Data
(60) Provisional application No. 63/685,483, filed on Aug. 21, 2024.

(51) Int. Cl. G06F 9/50

(52) U.S. Cl. CPC G06F 9/5027

(57) ABSTRACT

A method for managing computer resource use in computer-implemented risk assessment of a subject in respect of a context. Demographic subject data for the subject is passed to a first trained machine learning model trained on first context-specific historical risk outcomes correlated with historical demographic data corresponding to the demographic subject data. If a first threshold assessment from the first trained machine learning model is passed, the subject is approved. Responsive to failing the first threshold assessment, supplemental context-related subject data for the subject, in addition to the demographic subject data, is passed with the demographic subject data to a second trained machine learning model trained on second context-specific historical risk outcomes correlated with the historical demographic data and with historical context-related data corresponding to the supplemental context-related subject data. If a second threshold assessment from the second trained machine learning model is passed, the subject is approved.

### CROSS-REFERENCE TO RELATED APPLICATION

This application claims priority to, and the benefit of, U.S. Provisional Application No. 63/685,483 filed Aug. 21, 2024, the teachings of which are hereby incorporated by reference.

### TECHNICAL FIELD

The present disclosure relates to the management of computer resources, and more particularly to management of computer resource use where computers are used to carry out risk assessments.

### BACKGROUND

Risk assessments are used in a variety of contexts. To some extent risk assessments have been regularized, enabling them to be implemented by computer. The computer may receive inputs, such as answers to a questionnaire, and then apply a rule matrix to the answers to make an assessment of the risk. Typically, these approaches require the completion, transmission and processing of answers to the entire questionnaire, which may consume more computer resources, in terms of both processing and remote client-server connections, than is optimal.

### SUMMARY

In one aspect, the present disclosure is directed to a computer-implemented method for managing computer resource use when conducting a computer-implemented risk assessment of a subject in respect of a context. The method comprises receiving demographic subject data for the subject. The method further comprises passing the demographic subject data to a first trained machine learning model. The first trained machine learning model has been trained on first context-specific historical risk outcomes correlated with historical demographic data corresponding to the demographic subject data. The method further comprises receiving a first threshold assessment from the first trained machine learning model, and responsive to passing the first threshold assessment, approving the subject. Responsive to failing the first threshold assessment, the method further comprises receiving supplemental context-related subject data for the subject. The supplemental context-related subject data is in addition to the demographic subject data. Further responsive to failing the first threshold assessment, the method still further comprises passing the demographic subject data and the supplemental context-related subject data to a second trained machine learning model. The second trained machine learning model has been trained on second context-specific historical risk outcomes correlated with the historical demographic data and with historical context-related data corresponding to the supplemental context-related subject data. Further responsive to failing the first threshold assessment, the method yet further comprises receiving a second threshold assessment from the second trained machine learning model and, responsive to passing the second threshold assessment, approving the subject. Because receiving the supplemental context-related subject data for the subject, passing the demographic subject data and the supplemental context-related subject data to the second trained machine learning model and receiving the second threshold assessment from the second trained machine learning model occur only responsive to failing the first threshold assessment, use of computer resources associated with receiving the supplemental context-related subject data for the subject, passing the demographic subject data and the supplemental context-related subject data to the second trained machine learning model and receiving the second threshold assessment from the second trained machine learning mode is avoided where the subject passes the first threshold assessment test.

In some embodiments, the method further comprises, before passing the demographic subject data to the first trained machine learning model, applying a preliminary risk qualification test to the subject. In these embodiments, passing the demographic subject data to the first trained machine learning model occurs only responsive to passing the preliminary risk qualification test, and receiving the supplemental context-related subject data and passing the demographic subject data and the supplemental context-related subject data to the second trained machine learning model occurs responsive to either of failing the preliminary risk qualification test or failing the first threshold assessment. Because passing the demographic subject data to the first trained machine learning model occurs only responsive to passing the preliminary risk qualification test, additional use of computer resources associated with passing the demographic subject data to the first trained machine learning model and receiving the first threshold assessment from the first trained machine learning model is avoided where the subject fails the preliminary risk qualification test.

In some embodiments, the method further comprises, responsive to failing the second threshold assessment, undertaking further processing of the subject. Because the further processing of the subject is undertaken only responsive to failing the second threshold assessment, additional use of computer resources associated with the further processing of the subject is avoided where the subject passes the second threshold assessment.

In some embodiments, the method further comprises, responsive to failing the second threshold assessment, receiving additional context-related subject data for the subject. The additional context-related subject data is in addition to the demographic subject data and to the supplemental context-related subject data. In these embodiments, further responsive to failing the second threshold assessment, the method further comprises passing the demographic subject data, the supplemental context-related subject data and the additional context-related subject data to a third trained machine learning model. The third trained machine learning model has been trained on third context-specific historical risk outcomes correlated with the historical demographic data, the historical context-related data, and additional historical context-related data corresponding to the additional context-related subject data. Further responsive to failing the second threshold assessment, the method then further comprises receiving a third threshold assessment from the third trained machine learning model and, responsive to passing the third threshold assessment, approving the subject. Because receiving the additional context-related subject data for the subject, passing the demographic subject data, the supplemental context-related subject data and the additional context-related subject data to the third trained machine learning model and receiving the third threshold assessment from the third trained machine learning model occur only responsive to failing the second threshold assessment, use of computer resources associated with receiving the additional context-related subject data for the subject, passing the demographic subject data, the supplemental context-related subject data and the additional context-related subject data to the third trained machine learning model and receiving the third threshold assessment from the third trained machine learning mode is avoided where the subject passes the second threshold assessment test.

In some preferred embodiments, the first trained machine learning model is a first decision tree model, and in particularly preferred embodiments, the first decision tree model is a random forest model.

In some preferred embodiments, the second trained machine learning model is a second decision tree model, and in particularly preferred embodiments, the second decision tree model is a random forest model.

In some especially preferred embodiments, both the first trained machine learning model and the second trained machine learning model are random forest models.

In some embodiments, the method further comprises returning a respective model interpretation explaining at least one of the first threshold assessment and the second threshold assessment.

In some embodiments, the second trained machine learning model is a neural network. In some particular implementations of such embodiments, the first trained machine learning model is another neural network that is smaller than the second trained machine learning model.

In some embodiments, the first trained machine learning model is a first type of machine learning model and the second trained machine learning model is a second type of machine learning model and the first type of machine learning model is different from the second type of machine learning model.

In some embodiments, the subject is a human being.

In some embodiments, the subject is a non-human animal.

In some embodiments, the second trained machine learning model comprises a plurality of individual sub-models.

In some embodiments, the context requires health assessment, the demographic subject data omits any explicit salubriousness data and the supplemental context-related subject data includes explicit salubriousness data.

In some embodiments, the context is recruitment.

In some embodiments, the context is protection.

In another aspect, a computer-implemented method for managing computer resource use when conducting a risk assessment of a subject in respect of a context is provided. The method comprises receiving demographic subject data for the subject and applying a preliminary risk qualification test to the subject. Responsive to passing the preliminary risk qualification test, the method further comprises passing the demographic subject data to a first trained machine learning model. The first trained machine learning model has been trained on first context-specific historical risk outcomes correlated with historical demographic data corresponding to the demographic subject data. The method further comprises receiving a first threshold assessment from the first trained machine learning model and, responsive to passing the first threshold assessment, approving the subject. The method further comprises, responsive to failing the preliminary risk qualification test or to failing the first threshold assessment, receiving supplemental context-related subject data for the subject. The supplemental context-related subject data is in addition to the demographic subject data. Further responsive to failing the preliminary risk qualification test or to failing the first threshold assessment, the method further comprises passing the demographic subject data and the supplemental context-related subject data to a second trained machine learning model. The second trained machine learning model has been trained on second context-specific historical risk outcomes correlated with the historical demographic data and with historical context-related data corresponding to the supplemental context-related subject data. Further responsive to failing the preliminary risk qualification test or to failing the first threshold assessment, the method further comprises receiving a second threshold assessment from the second trained machine learning model and, responsive to passing the second threshold assessment, approving the subject. Because receiving the supplemental context-related subject data for the subject, passing the demographic subject data and the supplemental context-related subject data to the second trained machine learning model and receiving the second threshold assessment from the second trained machine learning model occurs only responsive to failing the preliminary risk qualification test or to failing the first threshold assessment, computer resource use associated with receiving the supplemental context-related subject data for the subject, passing the demographic subject data and the supplemental context-related subject data to the second trained machine learning model and receiving the second threshold assessment from the second trained machine learning model is avoided where the subject passes the preliminary risk qualification test or passes the first threshold assessment.

In some embodiments, the context requires health assessment, the demographic subject data omits any explicit salubriousness data, and the supplemental context-related subject data includes explicit salubriousness data.

In further aspects, the present disclosure is directed to a computer program product comprising at least one tangible, non-transitory computer readable medium embodying instructions which, when executed by at least one processor of a data processing system, cause the data processing system to implement any of the above-described methods.

In still further aspects, the present disclosure is directed to a data processing system comprising at least one processor and memory coupled to the at least one processor, wherein the memory contains instructions which, when executed by the at least one processor, cause the data processing system to implement any of the above-described methods.

### BRIEF DESCRIPTION OF THE DRAWINGS

These and other features will become more apparent from the following description in which reference is made to the appended drawings wherein:

FIG. 1 shows a computer network that comprises an example embodiment of a system for conducting computerized risk assessment;

FIG. 2 depicts an example embodiment of a server in a data center;

FIG. 3 is a flow chart showing a first illustrative, non-limiting method for managing computer resource use when conducting a computer-implemented risk assessment of a subject in respect of a context;

FIG. 4 is a flow chart showing a second illustrative, non-limiting method for managing computer resource use when conducting a computer-implemented risk assessment of a subject in respect of a context;

FIG. 4A is a schematic representation of the method of FIG. 4;

FIG. 5 shows an illustrative application of the random forest algorithm according to an aspect of the present disclosure;

FIG. 6 graphically illustrates application of the Local Interpretable Model-agnostic Explanations (LIME) methodology, according to an aspect of the present disclosure; and

FIG. 7 is an architectural diagram showing a non-limiting illustrative implementation of a system for managing computer resource use when conducting a computer-implemented risk assessment.

### DETAILED DESCRIPTION

Broadly speaking, the present disclosure describes systems, methods and computer program products for managing computer resource use when conducting a computer-implemented risk assessment of a subject in respect of a context. Examples of computer resources include processing capacity (compute), data storage capacity, and communication infrastructure.

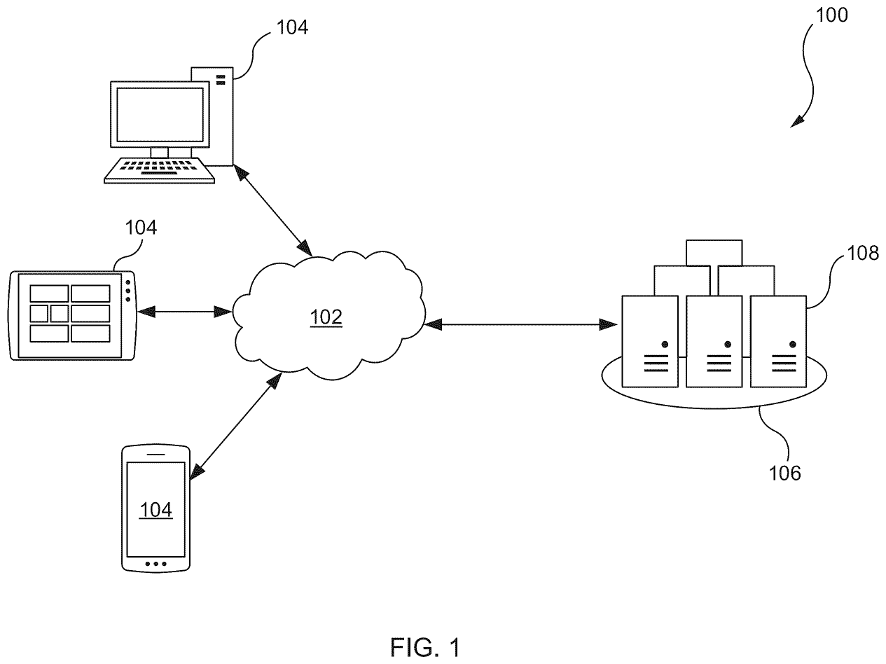

Referring now to FIG. 1, there is shown a computer network 100 that comprises an example embodiment of a system for conducting a computer-implemented risk assessment of a subject in respect of a context. More particularly, the computer network 100 comprises a wide area network 102 such as the Internet to which various client devices 104 and data center 106 are communicatively coupled. The client devices 104 may be used by an individual who is, or who is representing, a subject of the risk assessment. The data center 106 comprises a number of servers 108 networked together to collectively perform various computing functions related to conducting a computer-implemented risk assessment of a subject in respect of a context.

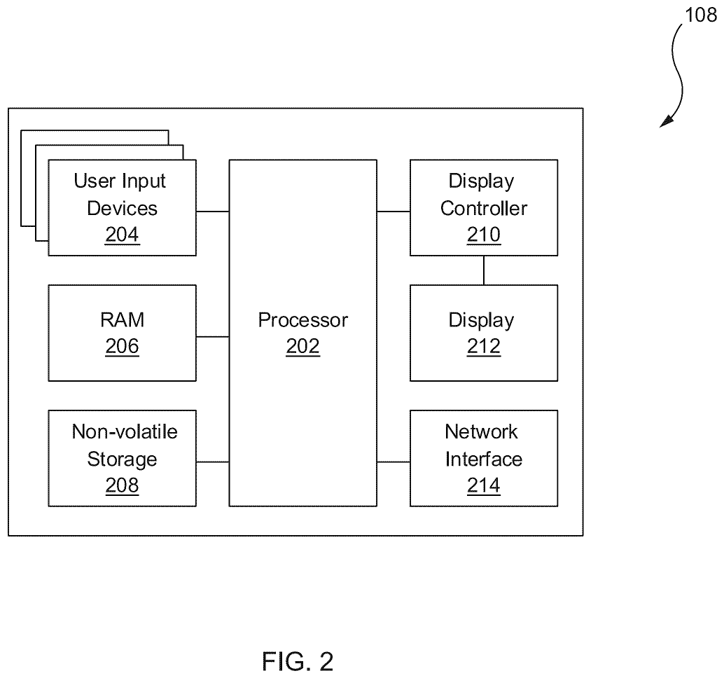

Referring now to FIG. 2, there is depicted an example embodiment of one of the servers 108 that comprises the data center 106. The server comprises a processor 202 that controls the overall operation of the server 108. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for conducting a computer-implemented risk assessment of a subject in respect of a context, as is described in more detail below. Additionally or alternatively, the servers 108 may collectively perform that method using distributed computing. While the system depicted in FIG. 2 is described specifically in respect of one of the servers 108, analogous versions of the system may also be used for the client devices 104.

The subject may be, for example, a human individual, or a non-human animal, such as a dog, or a cat, or a bird, or other companion animal or working animal (e.g. a circus animal, or a police canine, or a guide dog or other support dog, or an assistance monkey, for example). The context may be, for example, recruitment (e.g. an employment application/screening), or protection such as insurance (e.g. an insurance application for health or life insurance for a human individual or an insurance application for health insurance for a pet, or for life insurance for a pet, or for vehicle insurance or other suitable types of insurance). In the recruitment context, there may be some career roles (e.g. firefighter or police officer) which have certain fitness requirements either explicitly (e.g. a physical fitness test) or implicitly (e.g. a demanding physical training program) or both. In this context, it may be desirable to assess the risk that an applicant would fail the fitness test and/or training so as to avoid wasted resources in administering the fitness test, or the even greater waste of resources in inducting an unsuccessful candidate into a training program, which may displace a candidate who would have completed the training. In the insurance context, the objective is generally to be profitable (or at least solvent in the case of non-profit insurance), so it is desirable to assess the risk that an individual may experience circumstances leading to a claim, such as medical conditions (health insurance), death (life insurance) or car accidents (vehicle insurance). Recruitment and protection are merely illustrative examples of contexts for risk assessment and are not limiting. Moreover, the claims of the present disclosure are not directed to employment screening or insurance applications, but rather to managing computer resource use when conducting a computer-implemented risk assessment, for which employment screening or insurance applications are merely illustrative contexts in respect of which the technical teachings of the disclosure may be employed. It is also noted that nothing in this document should be understood to suggest any form of risk assessment, including employment screening and underwriting, that is not fully in compliance with all applicable laws for the relevant jurisdiction(s).

The present technology deploys machine learning risk assessment, which proceeds in incremental stages so as to improve performance by avoiding the computational cost of obtaining and processing information that is ultimately unnecessary to perform the risk assessment. Using external public data, proprietary historical data and demographic information, trained machine learning models according to aspects of the present disclosure can predict risk factors in the absence of certain information, further improving processing.

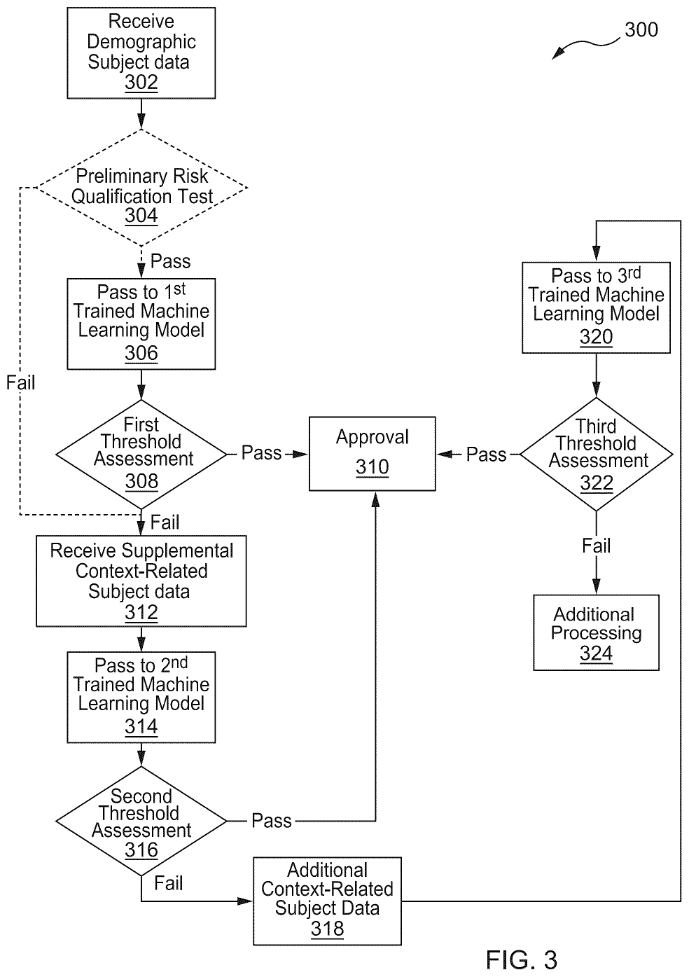

Reference is now made to FIG. 3, which is a flow chart showing an illustrative, non-limiting method 300 for managing computer resource use when conducting a computer-implemented risk assessment of a subject in respect of a context.

At step 302, the method 300 receives demographic subject data for the subject. The demographic subject data may be obtained, for example, by entering information into a web page as part of an online application process. In the case of a human individual, the demographic subject data may comprise, for example, the following information (in all cases only information that can be lawfully collected and used for the particular context would be collected):
Age;
Postal code/zip code;
Gender;
Height;
Weight;
Citizenship status; and
Smoker or non-smoker (optionally).

The exact nature of the demographic data will depend on the context of the risk assessment. The foregoing list is neither exhaustive nor exclusive; some factors may be omitted in some contexts and additional factors may be included in some contexts. For example, where the context is protection, and in particular insurance, the value and duration of the insurance coverage sought (e.g. term life insurance) may be included in the demographic data.

Basic profile information, such as name and address, and possibly citizenship/work eligibility, may be collected as part of the demographic subject data, or may be collected separately. For example, a job applicant may have already provided basic profile information previously. In some instances aspects of the demographic subject data may be received indirectly, for example if a subject has provided a date of birth, the subject's age may be calculated from the date of birth.

In one preferred embodiment, the context requires health assessment, but the demographic subject data omits any explicit salubriousness data, or omits any explicit salubriousness data other than information about smoking/non-smoking (i.e. omits any non-tobacco salubriousness data). The term “salubriousness”, as used herein, encompasses both explicit health and medical conditions as well as explicit health-relevant lifestyle factors. Of note, age, height and weight (and other basic demographics) as not considered to be explicit salubriousness data because they are not necessarily indicative of health. For example weight, or weight and height together (e.g. ratios like Body Mass Index (BMI)) are not indicative of health because weight alone does not distinguish between fat mass and lean body mass (muscle, organ, bone, connective tissue, etc.). A BMI score of 26.7, indicating “overweight”, applies equally to someone with significant visceral and abdominal fat (and who carries the associated health risks) and to a lean, well-muscled natural bodybuilder. Likewise, age is not necessarily indicative of health: a 50-year-old active duty soldier may be in far better health than an obese sedentary 20-year-old.

At optional step 304, the method 300 applies a preliminary risk qualification test to the subject. The preliminary risk qualification test determines whether it is appropriate for the subject to undergo initial risk assessment based on the demographic subject data alone, or if additional data is required. In a recruitment context, the preliminary risk qualification test may be based on a role for which a subject is applying. For example, in a police department, it may be determined that a parking enforcement officer role is suitable for initial risk assessment based on the demographic subject data alone whereas the greater physical demands placed on frontline police officers require additional data for the computerized risk assessment. In a protection context such as insurance, the preliminary risk qualification test may be based at least in part on the amount of insurance sought; if the amount of insurance sought is below a set value it may be appropriate for the subject to undergo initial risk assessment based on the demographic subject data alone, but additional data may be required if the amount of insurance sought is above the set value. Responsive to failing the preliminary risk qualification test (“fail” at optional step 304), the method 300 bypasses steps 306 and 308 and proceeds to step 312 described further below.

Responsive to passing the preliminary risk qualification test (“pass” at optional step 304), the method 300 proceeds to step 306. At step 306, the method 300 passes the demographic subject data to a first trained machine learning model. In a preferred embodiment, the first trained machine learning model is a decision tree model, and in a particularly preferred embodiment, the decision tree model is a random forest model. Other machine learning models are also contemplated. For example, and without limitation, the first machine model may be a neural network. The first trained machine learning model has been trained on first context-specific historical risk outcomes correlated with historical demographic data corresponding to the demographic subject data. The term “context-specific historical risk outcomes” refers to historical risk outcomes that are relevant to the context of the risk assessment. For example, in a recruitment context, the first trained machine learning model may have been trained using historical demographic data for past subjects and historical risk outcomes of whether those past subjects successfully completed a fitness screening, or successfully completed training. In a protection context such as life insurance, the first trained machine learning model may have been trained using historical demographic data for past subjects and historical risk outcomes of whether those past subjects were the subject of a claim within a predetermined period (e.g. 5 or 10 years), which may be obtained from claims data. After step 306, the method 300 proceeds to step 308.

At step 308, the method 300 receives a first threshold assessment from the first trained machine learning model. The first threshold assessment may be a binary assessment (e.g. pass/fail) or a probability assessment (e.g. a probability that an applicant will successfully complete a fitness test or a training program, or a probability that an applicant will have an insurance claim within a predetermined period). In the case of a probability assessment, whether a subject passes or fails the first threshold assessment may depend on one or more additional factors beyond the probability. For example, in the context of insurance there may be probability tiers depending on the insurance amount sought, with higher insurance amounts requiring a lower probability that an applicant will have a claim within a predetermined period to “pass” the first threshold assessment.

Responsive to passing the first threshold assessment (“pass” at step 308), the method proceeds to step 310, where the subject is approved. For example, in the recruitment context a subject may be approved to undertake a fitness test or begin a training program, or in the protection context, a subject may be approved for an insurance policy.

Responsive to failing the preliminary risk qualification test (“fail” at optional step 304) or to failing the first threshold assessment (“fail” at step 308), the method 300 proceeds to step 312. At step 312, the method 300 receives supplemental context-related subject data for the subject. The supplemental context-related subject data is in addition to the demographic subject data. The term “context-related”, as used in reference to subject data, refers to relevance of the subject matter to the context of the risk assessment. Thus, in a preferred embodiment in which the context requires health assessment, the supplemental context-related subject data includes explicit salubriousness data. As with the demographic subject data obtained at step 302, the supplemental context-related subject data may be obtained, for example, by entering information into a web page as part of an online application process. After receiving the supplemental context-related subject data, the method 300 proceeds to step 314.

At step 314, the method 300 passes the demographic subject data obtained at step 302 and the supplemental context-related subject data obtained at step 312 to a second trained machine learning model. This second trained machine learning model has been trained on second context-specific historical risk outcomes correlated with the historical demographic data and with historical context-related data corresponding to the supplemental context-related subject data. In a preferred embodiment in which the context requires health assessment, the historical context-related subject data includes explicit salubriousness data corresponding to the explicit salubriousness data included in the supplemental context-related subject data received at step 312. In a preferred embodiment, the second trained machine learning model at step 314 is a decision tree model, and in a particularly preferred embodiment, the decision tree model is a random forest model. Other machine learning models are also contemplated. For example, and without limitation, the second machine model may be a neural network. In embodiments in which both the first trained machine learning model at step 306 and the second trained machine learning model at step 314 are neural networks, the neural network for the first trained machine learning model is preferably smaller than the neural network for the second trained machine learning model. This embodiment promotes efficiency because in cases where the neural network for the first trained machine learning model is able to approve the subject, this avoids unnecessary processing with the larger neural network for the second trained machine learning model, thereby conserving computing resources.

In some embodiments, the second trained machine learning model comprises a plurality of individual sub-models. For example, in a preferred embodiment in which the context requires health assessment, there may be different sub-models for different health conditions, e.g. one sub-model for high blood pressure, one sub-model for sleep apnea, one sub-model for high cholesterol, etc. The supplemental context-related subject data received at step 312 will include salubriousness data that is needed for the second trained machine learning model (including any sub-models) at step 314. The specific salubriousness data that may be needed will depend upon the particular health conditions, and will be based upon the inputs to the second trained machine learning model (including any sub-models). Determination of the relevant salubriousness data is within the capability of one of ordinary skill in the art, now informed by the present disclosure. The sub-models can be expanded or replaced with other sub-models based on the specific health qualifications required. In one preferred embodiment, each of the sub-models is a decision tree model, and in one particularly preferred embodiment, each of the sub-models is a random forest model.

At step 316, the method 300 receives a second threshold assessment from the second trained machine learning model. As with the first threshold assessment received at step 308, the second threshold assessment received from the second trained machine learning model at step 316 may be a binary assessment or a probability assessment. In embodiments in which there are a plurality of sub-models, the second threshold assessment may comprise a plurality of individual sub-assessments based on respective ones of the sub-models, and “passing” the second threshold assessment at step 316 may require passing all of the individual sub-assessments.

Responsive to passing the second threshold assessment (“pass” at step 316), the method 300 proceeds to step 310, where the subject is approved.

Responsive to failing the second threshold assessment (“fail” at step 316), the method 300 proceeds to step 318.

At step 318, the method 300 receives additional context-related subject data for the subject. The additional context-related subject data received at step 318 is in addition to the demographic subject data received at step 302 and also in addition to the supplemental context-related subject data received at step 312. As with the demographic subject data obtained at step 302 and the supplemental context-related subject data obtained at step 312, the additional context-related subject data may be obtained, for example, by entering information into a web page as part of an online application process.

At step 320, the method 300 passes the demographic subject data, the supplemental context-related subject data and the additional context-related subject data to a third trained machine learning model. The third trained machine learning model has been trained on third context-specific historical risk outcomes correlated with the historical demographic data, the historical context-related data (which corresponds to the supplemental context-related subject data received at step 312), and additional historical context-related data corresponding to the additional context-related subject data.

In a preferred embodiment in which the context requires health assessment, the additional context-related subject data received at step 318 also includes explicit salubriousness data; this explicit salubriousness data may be more detailed and/or more invasive than the explicit salubriousness data included in the supplemental context-related subject data received at step 312, and may include biological test results or medical reports. The additional historical context-related data includes explicit salubriousness data corresponding to the explicit salubriousness data included in the additional context-related subject data.

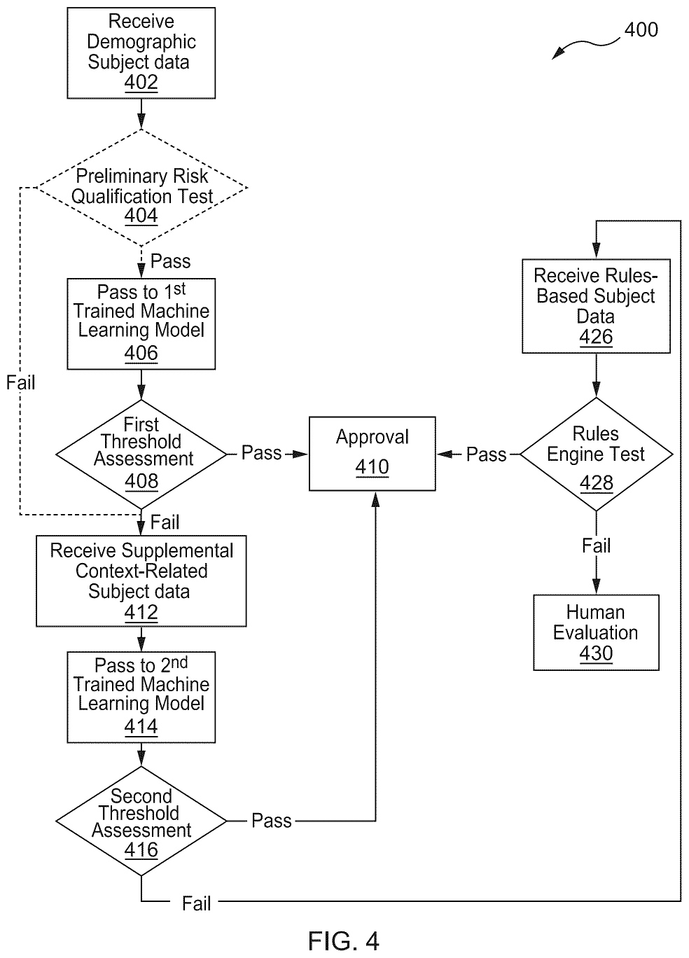

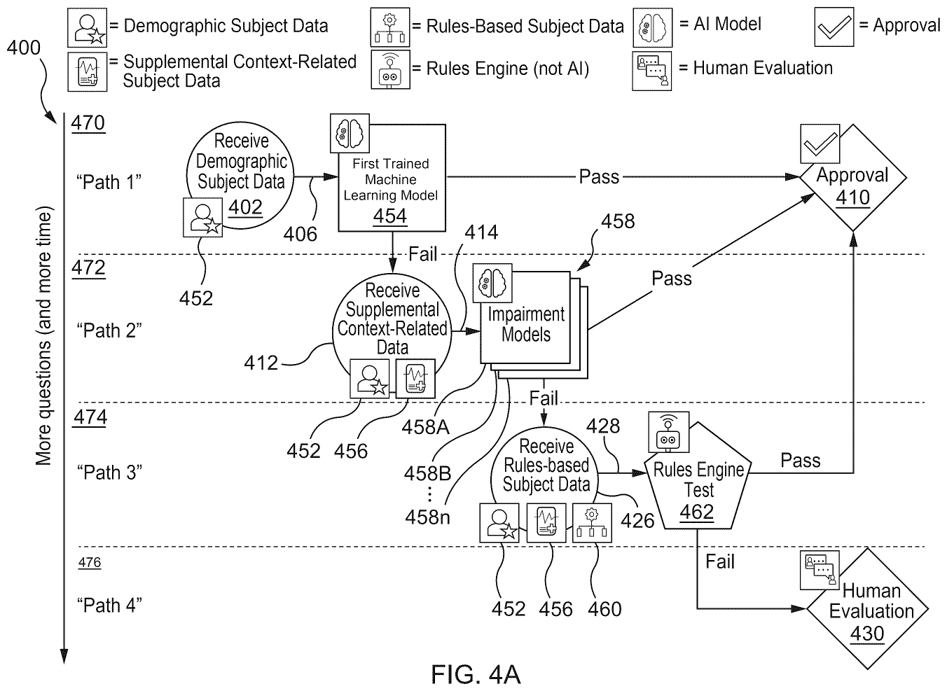

At step 322, the method 300 receives a third threshold assessment from the third trained machine learning model. Responsive to passing the third threshold assessment (“pass” at step 322), the method 300 proceeds to step 310 to approve the subject. Responsive to failing the third threshold assessment (“fail” at step 322), the method 300 proceeds to step 324 to undertake additional processing of the subject. The additional processing at step 324 may comprise, for example, flagging the subject for specialized assessment. This may be, for example, a more conventional rule-based assessment (e.g. analogous to steps 426 to 428 in FIG. 4) and/or evaluation by a human evaluator (e.g. analogous to step 430 in FIG. 4). The additional processing at step 324 may also be a rejection of the subject. Or, the additional processing at step 324 may comprise one or more iterations of receiving further subject data and passing the further subject data, along with the previously received subject data, to respective further trained machine learning models, analogously to steps 312 to 316 and steps 318 to 322.

FIG. 4 is a flow chart showing a second illustrative, non-limiting method 400 for managing computer resource use when conducting a computer-implemented risk assessment of a subject in respect of a context. The method 400 shown in FIG. 4 is similar to the method 300 shown in FIG. 3, with like reference numerals denoting like features, except with the prefix “4” instead of “3”. The method 400 shown in FIG. 4 differs from the method 300 shown in FIG. 3 in that, responsive to failing the second threshold assessment at step 416, instead of receiving additional context-related subject data for the subject, the method 400 receives rules-based subject data at step 426 and passes the rules based subject data to a rules engine test at step 428. Responsive to passing the rules engine test (“pass” at step 428), the method 400 proceeds to step 410 to approve the subject. Responsive to failing the rules engine test (“fail” at step 428), the method 400 proceeds to step 430 where the subject is referred to human evaluation. Thus, the method 400 shown in FIG. 4 has only two threshold assessments, rather than three as in the method 300 shown in FIG. 3.

Reference is now made to FIG. 4A, which shows the illustrative method 400 schematically rather than in flow chart form, without optional step 404. Illustrative aspects of how the method 400 may be applied where the context is protection, and in particular life insurance, will now be described in the context of FIG. 4A.

In addition to improvements in computer efficiency, application of the methods described herein may provide the supplemental benefit of addressing certain “pain points” associated with the current life insurance application process: the application process is a one-size-fits-all approach. It often takes too long, and the application questions are unclear and confusing, and assessments are too invasive, leading to a high drop off rate in the application process. This is not merely a financial issue, and the claims of the present disclosure are not directed to any financial method or to attempting to influence the behaviour of any participant in the computer-implemented risk assessment but only to managing computer resource use when conducting such a risk assessment. Applicant drop off is an issue that hinders efficient use of computing resources. Where applications are commenced online but are not completed, the computer resources that were deployed to support those abandoned applications are wasted.

Continuing to refer to FIG. 4A, at step 402, the method 400 receives demographic subject data 452 for the subject, which is passed at step 406 to a first trained machine learning model 454. At step 408 (FIG. 4), the method 400 receives a first threshold assessment from the first trained machine learning model 454. Passing the first threshold assessment (“pass” at step 408 in FIG. 4) leads to approval 410. For example, in an online life insurance application, applicants are first asked basic questions via an online application portal (weight, height, age, address, occupation, etc.) to obtain the demographic subject data 452. Of note, the demographic subject data 452 excludes any explicit salubriousness data. Without any questions regarding medical impairments, the first trained machine learning model 454 leverages the demographic subject data 452 in combination with the public external data and claims historical data used for training to determine if the applicant may be automatically approved via Straight-Through Processing (STP). Accordingly, in some embodiments the first trained machine learning model 454 may be an “auto-approval model” that can assess risk and approve a segment of applicants after they answer some basic demographic questions. Aspects of the present disclosure can therefore provide automatic approval of the lowest-risk applicants via machine learning (e.g. random forest classifiers).

Responsive to failing the first threshold assessment (“fail” at step 408 in FIG. 4), at step 412, the method 400 receives supplemental context-related subject data 456 for the subject. Optionally, in a protection context such as insurance, failing the first threshold assessment (“fail” at step 408 in FIG. 4) may result in a higher risk score being assigned to the subject in the event of later approval at step 410, which may result in different terms and conditions. After step 412, at step 414, the method 400 passes the demographic subject data 452 and the supplemental context-related subject data 456 to a second trained machine learning model 458 comprising a plurality of sub-models 458A, 458B, . . . 458n. At step 416 (FIG. 4), the method 400 receives a second threshold assessment from the second trained machine learning model 458. Responsive to passing the second threshold assessment (“pass” at step 416 in FIG. 4), the method 400 proceeds to approval 410. For example, in an online life insurance application, applicants that cannot be automatically approved by the first trained machine learning model 454 (i.e., above model risk threshold), can be asked limited medical history questions (explicit salubriousness data) relevant to the most common impairments such as high blood pressure, asthma, etc. to obtain the supplemental context-related subject data 456. From the supplemental context-related subject data 456, the second trained machine learning model 458 can internally predict the applicant's answers to follow-up questions that would be necessary to assign risk, without the questions actually being asked. The second trained machine learning model 458 may then determine if an applicant falls below a set risk threshold (passes the second threshold assessment at step 416 in FIG. 4) and hence, be automatically approved via STP.

As noted above, in the illustrated embodiment the second trained machine learning model 458 comprises a plurality of sub-models 458A, 458B, . . . 458n. The sub-models 458A, 458B, . . . 458n may be individual trained machine learning models which are trained to assess specific health impairments without needing to obtain information from invasive questions. In one embodiment, the sub-models 458A, 458B, . . . 458n are “impairment models” that predict applicant answers to follow-up medical questions, thereby eliminating the need to actually ask these follow-up questions and avoiding the associated computer resource use. This approach is referred to herein as “internal response prediction.” Thus, aspects of the present disclosure can provide for risk assessment by internal response prediction via machine learning (e.g. random forest classifiers).

Responsive to failing the second threshold assessment (“fail” at step 416 in FIG. 4), at step 426 the method 400 receives rules-based subject data 460 and at step 428 passes the rules-based subject data 460 to a rules engine test 462. Responsive to passing the rules engine test (“pass” at step 428 in FIG. 4), the method 400 proceeds to approval 410. For example, in an online life insurance application, applicants that remain above the risk threshold for the second trained machine learning model 458 may be sent to an underwriting rules engine (i.e., a deterministic if-then engine) which obtains answers to reflexive follow-up questions and applies the rules engine test 462. Answers given to questions at this stage may give applicants another opportunity to meet the threshold for STP. Any relevant previously provided answers (i.e. demographic subject data 452 and supplemental context-related subject data 456) are automatically reformatted for the underwriting rules engine so that repetitive questions are avoided. In some embodiments, where appropriate consents have been obtained and in all cases only in full compliance with law, the method 400 may include integration with providers of electronic health records to pre-populate answers to health questions used in the rules engine test 462. Responsive to failing the rules engine test 462 (“fail” at step 428 in FIG. 4), at step 430 the subject is referred to human evaluation 430.

In the illustrative embodiment shown in FIG. 4A, there are four conceptual “paths” the subject user can take. Aspects of the present disclosure are focused on enabling the first two paths, so as to provide improved computer resource utilization, with integration to the other paths.

“Path 1” 470 represents evaluation by the first trained machine learning model 454 based on only the demographic subject data 452, and “path 2” 472 represents evaluation by the second trained machine learning model 458 based on both the demographic subject data 452 and the supplemental context-related subject data 456. “Path 3” 474 represents evaluation by the rules engine test 462 based on the demographic subject data 452, the supplemental context-related subject data 456 and the rules-based subject data 460. As noted, some of the demographic subject data 452 and/or the supplemental context-related subject data 456 may be used as input into the rules engine test 462; i.e. it is not necessary to collect duplicative data. Thus, where approval is obtained via “path 1” 470, “path 2” 472 or “path 3” 474, there is a single touchpoint, seamless with the prior application flow. This reduces the risk of a discontinued application and the resultant squandered computer resources. Finally, “path 4” 476 represents human evaluation 430. For example, this may involve reviewing the results of physical examination and/or fluid testing, as permitted by law in the relevant jurisdiction.

The use of multiple conceptual “paths” allows the required processing to be increased incrementally based on the risk profile. In “path 2” 472, the use of sub-models 458A, 458B, . . . 458n in the form of “impairment models” allows for evaluation of individual conditions, so that questions need only be asked (and computer resources consumed) for relevant conditions.

One of ordinary skill in the art, now informed by the present disclosure, will appreciate how the approach described in the context of FIG. 4A can be extended for the method 300 shown in FIG. 3, and may be applied mutatis mutandis to other contexts besides protection, such as recruitment.

In a preferred embodiment the trained machine learning models (e.g. the first trained machine learning model 454 and the second trained machine learning model 458) are decision tree models, in a particularly preferred embodiment, the decision tree models are random forest models. Thus, in a particularly preferred embodiment the first trained machine learning model 454 and the second trained machine learning model 458 are both random forest models. The random forest model implements a robust, tree-based algorithm that is particularly well-suited for classification tasks and is well suited for automating risk assessments and internal response predictions.

The random forest model comprises multiple decision trees, making it a powerful tool for handling complex datasets. It uses bootstrap aggregation (“bagging”) to create diverse subsets of data, training each tree on a different subset. This reduces overfitting and enhances the model's generalizability. By averaging the results of multiple trees, the random forest model generally delivers high accuracy and stability, even with noisy data. While the present disclosure contemplates the use of one or more neural networks for the trained machine learning models as an alternative to the random forest model, the random forest model is preferred for several reasons, including:
Ease of Training: The random forest model requires less hyperparameter tuning compared to neural networks, making it simpler to implement, and requires less data to generalize than a neural network.
Interpretability: The decisions made by random forest models are easier to interpret, providing clearer insights into how features contribute to predictions.
Lower Computational Cost: Random forest models are generally less computationally intensive than neural networks, making them more efficient for applications with limited resources. Because an important aspect of the present disclosure is to manage computer resource use when conducting a computer-implemented risk assessment, the lower computational cost is a key consideration.

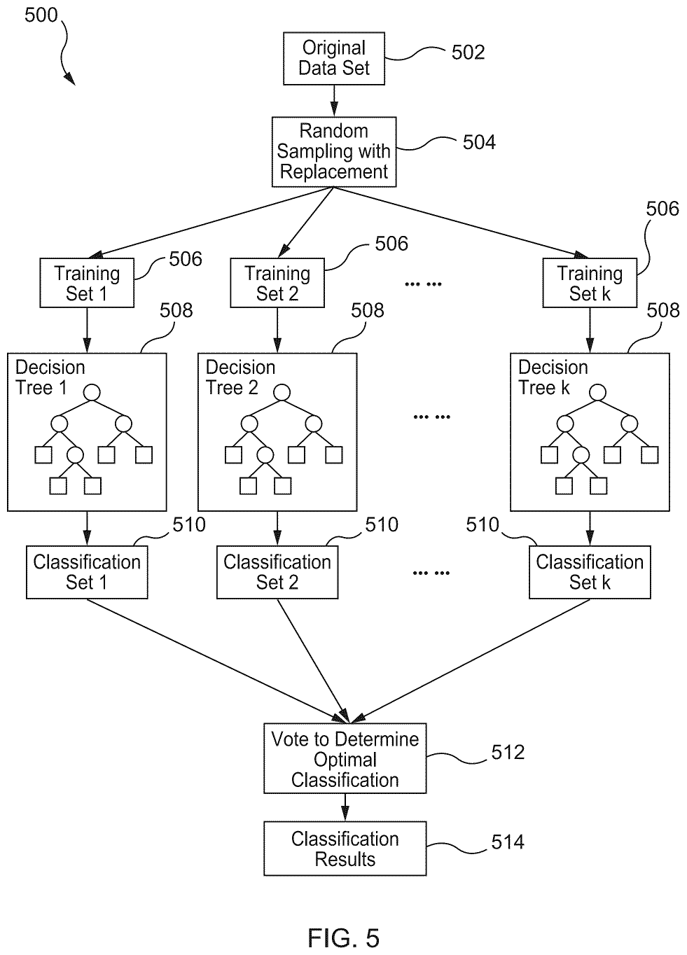

In broad overview, with reference to FIG. 5, an illustrative embodiment of the random forest algorithm, denoted generally at 500, proceeds as follows:
1. Data Sampling: Beginning with an original data set 502, the random forest model randomly selects subsets of data with replacement (bootstrapping) 504 to create multiple training sets 506.
2. Tree Construction: For each training set 506, a respective decision tree 508 is constructed by recursively splitting the data based on feature values that maximize the separation of classes.
3. Voting Mechanism: Each decision tree 508 in the “forest” makes a classification decision, producing a respective classification set 510. The final prediction is determined by majority voting 512, where the class receiving the most votes across all trees is chosen.
4. Aggregation: The results from all trees are aggregated to produce the final prediction 514, ensuring robustness and reducing the variance compared to a single decision tree.

The table below shows examples of impurities that can be used to split the data and construct the decision tree.

| Impurity | Task | Formula | Description |
|---|---|---|---|
| Gini Impurity | Classification | ${\sum }_{i = 1}^{C} {f}_{i} ( 1 - {f}_{i} )$ | fᵢ is the frequency of label i at a node and |
| | | | C is the number of |
| | | | unique labels. |
| Entropy | Classification | ${\sum }_{i = 1}^{C} - {f}_{i} log ( {f}_{i} )$ | fᵢ is the frequency of label i at a node and |
| | | | C is the number of |
| | | | unique labels. |
| Variance/ Mean Square | Regression | $\frac{1}{N} {\sum }_{i = 1}^{N} {( {y}_{i} - μ )}^{2}$ | yᵢ is label for an instance, N is the |
| Error (MSE) | | | number of instances |
| | | | and μ is the mean |
| | | | $given by \frac{1}{N} {\sum }_{i = 1}^{N} {y}_{i}$ |
| Variance/ Mean | Regression | $\frac{1}{N} {\sum }_{i = 1}^{N} \vert {y}_{i} - μ \vert$ | yᵢ is label for an instance, N is the |
| Absolute | | | number of instances |
| Error (MAE) | | | and μ is the mean |
| | | | $given by \frac{1}{N} {\sum }_{i = 1}^{N} {y}_{i}$ |

In a currently preferred embodiment, the sub-models 458A, 458B, . . . 458n (impairment models) are random forest models trained on the following features (which may be used for the supplemental context-related subject data 456):
Gender;
Age;
Education level;
Marital status;
Ratio of family income to poverty;
Current self-reported height;
Current self-reported weight;
Hours worked last week in total all jobs;
Overall work schedule past 3 months;
Vigorous work activity;
Number of days vigorous work;
Minutes vigorous-intensity work;
Minutes sedentary activity; and
Model-specific feature(s) (e.g. “Have you ever been diagnosed with high blood pressure?)”

Class imbalance in the dataset may be addressed by employing weighted metrics both for fine-tuning and testing. This assists in having the evaluation metrics reflect the true performance of the model across all classes, helping to avoid biases towards the majority class and providing a more balanced assessment.

In a preferred embodiment, model precision is designed to reduce false positives (e.g. approving a subject that should not have been approved), which may be achieved by using randomized cross-validation for tuning the sub-models' hyperparameters. The following hyperparameters may be tuned:
Number of trees in the forest;
Maximum depth of the trees;
Minimum number of samples required to split an internal node;
Minimum number of samples required to be at a leaf node;
Whether bootstrap samples are used when building trees;
Number of features to consider when looking for the best split;
Function to measure the quality of a split;
Weights associated with classes;
Whether to use out-of-bag samples to estimate the generalization accuracy;
Reuse the solution of the previous call to fit and add more estimators to the ensemble.

In alternate embodiments, different types of machine learning models may be used. Thus, in one non-limiting embodiment, the first trained machine learning model is a first type of machine learning model and the second trained machine learning model is a second type of machine learning model and the first type of machine learning model is different from the second type of machine learning model. For example, the first trained machine learning model may be a neural network and the second trained machine learning model may be a random forest model, or vice versa.

The machine learning models may be trained to become trained machine learning models using publicly available healthcare data (for example, Centers for Disease Control and Prevention data) as well as historical data (e.g. application data and applicant success data in a recruitment context, or claim history data and past application data in a protection context such as insurance). Optionally, synthetic data may be generated from the historical data to protect privacy while retaining the risk patterns. One suitable source of training data for the machine learning models is the National Health and Nutrition Examination Survey (NHANES) made available by the National Center for Health Statistics of the Centers for Disease Control and Prevention: https://wwwn.cdc.gov/nchs/nhanes/search/datapage.aspx?Component=Questionnaire&Cycle=2017-2020.

In preferred embodiments, when the methods 300, 400 receive the first threshold assessment (steps 308, 408), the second threshold assessment (steps 316, 416) and, in the case of the method 300 in FIG. 3, the third threshold assessment (step 322), one or more respective model interpretations are also returned. The respective model interpretations explain, as applicable, the first threshold assessment, the second threshold assessment and the third threshold assessment. The use of model interpretations supports validation and, in cases where the subject is a human, can enable the identification and expurgation of improper biases in the trained machine learning models. Preferred embodiments in which the trained machine learning models are random forest models support the use of model interpretations.

One non-limiting example of an algorithm for model interpretation is Local Interpretable Model-agnostic Explanations (LIME), see: https://arxiv.org/abs/1602.04938v3. LIME is an algorithm designed to improve the interpretability of machine learning models. LIME can help to explain the predictions made by machine learning models, providing improved transparency and trust in automated decision-making processes.

LIME provides explanations for individual predictions, helping to understand the model's behavior on a case-by-case basis. It identifies the most influential features for each prediction, aiding in the detection of model biases and areas for improvement. Furthermore, it is model agnostic, enabling it to be applied to a wide range of machine learning models, allowing the flexibility to change the model type in the future (e.g. from a random forest model to a neural network).

In overview, the LIME algorithm proceeds in four stages:

1. Model Prediction: LIME starts with a prediction from a complex, black-box model (for example a random forest model, or a neural network).

2. Perturbation: It perturbs the data point being explained by making slight modifications to its features, creating a new dataset of similar instances.

3. Local Model Training: LIME trains a simple, interpretable model (e.g., linear regression) on the new dataset, focusing on the local behavior around the data point.

4. Explanation Generation: The simple model's coefficients are used to generate an explanation for the original prediction, highlighting the most influential features.

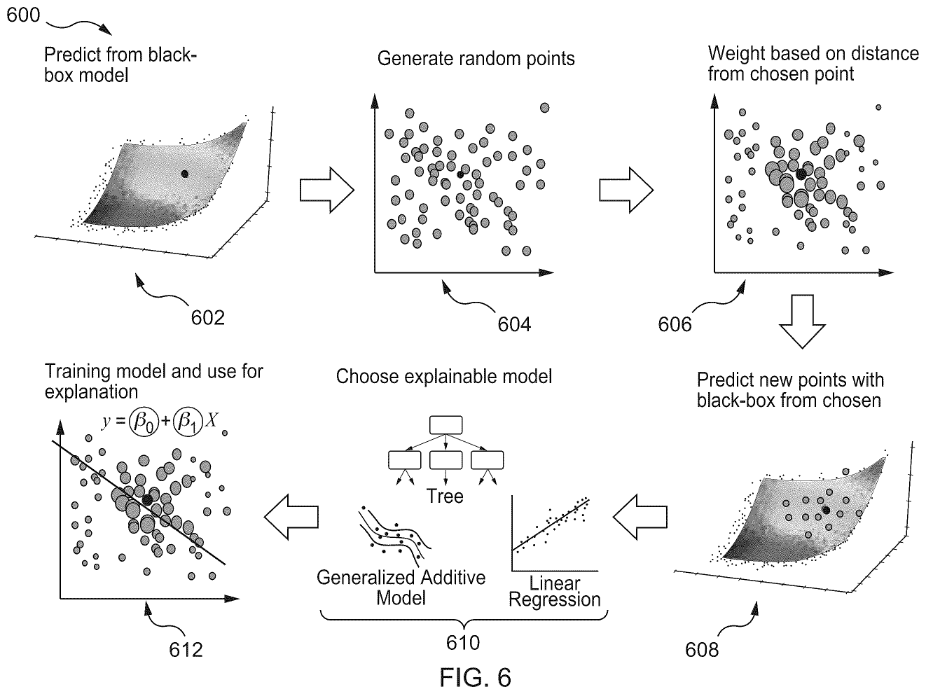

Reference is now made to FIG. 6, which graphically illustrates application of the LIME methodology, which is indicated generally at 600. The methodology 600 begins at step 602 with a prediction from a complex, black-box model. At step 604, random points are generated, and at step 606, the random points are weighted based on their distance from the prediction (in step 602). At step 608, the random points are used to generate new predictions from the black-box model and then at step 610 an explainable model is selected. At step 612, the model selected at step 610 is trained using the dataset (new predictions) from step 608 and used to explain (identify the most influential features for) the original prediction in step 602.

An illustrative LIME algorithm is set out below.

```
Algorithm 1 Sparse Linear Explanations using LIME
Require: Classifier f, Number of samples N
Require: Instance x, and its interpretable version x′
Require: Similarity kernel πₓ, Length of explanation K [symbol]
  ← { }
  for i ∈ {1, 2, 3, ..., N} do [symbol]
    ← sample_around(x′) [symbol]
    ← [symbol]   ∪ [symbol] [symbol]     , f(zᵢ), πₓ(zᵢ) [symbol]
  end for
  w ← K − Lasso( [symbol]   , K) [symbol]   with [symbol]   as features, f(z) as target
return w
```

The model interpretations may be provided by an explainability module. For every threshold assessment from a machine learning model, a detailed report may be generated, offering insights into the model's decision-making process. This allows a support team (e.g. underwriters in a protection context, or recruiters in a recruiting context) to analyze which factors about the subject influenced the model's inference, thereby identifying any gaps that need to be addressed or areas where the model requires retraining.

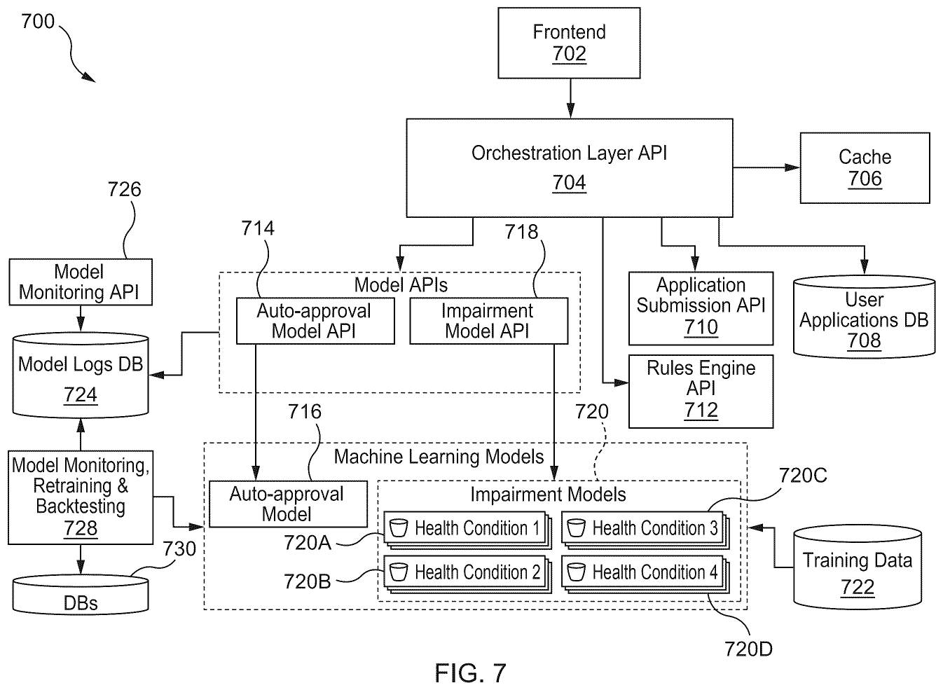

Reference is now made to FIG. 7, which is an architectural diagram showing a non-limiting illustrative implementation of a system 700 for managing computer resource use when conducting a computer-implemented risk assessment. The system 700 may be used for risk assessment in, for example, a recruitment context or a protection context, and may implement the method 400 shown in FIGS. 4 and 4A.

The system 700 comprises a frontend 702, an orchestration layer application programming interface (API) 704, a cache 706, a user applications database 708, an application submission API 710, a rules engine API 712 configured for sending data to a rules engine, and a plurality of model APIs which interface with respective trained machine learning models. The model APIs comprise a first model API 714 that interfaces with a first trained machine learning model 716, and a second model API 718 that communicates with a second trained machine learning model 720, which comprises a plurality of sub-models 720A to 720D. In the illustrated embodiment, the first trained machine learning model 716 is an auto-approval model 716 (as described above) and the sub-models 720A to 720D that make up the second trained machine learning model 720 are impairment models 720A to 720D, each of which is configured for internal response prediction for a different health condition. While four impairment models 720A to 720D are shown for purposes of illustration, there may be any number of impairment models. The first trained machine learning model 716 and the second trained machine learning model 720 are trained using training data from a training database 722.

The model APIs 714, 718 also interface with a model logs database 724 to store decisions from the first trained machine learning model 716 and the second trained machine learning model 720. The model logs database 724 supports a model monitoring, retraining and backtesting module 728 which optionally communicates with one or more additional databases 730. Although shown as a single module 728 for ease of illustration, there may in practice be, for example, separate modules for each of model monitoring, model retraining and model backtesting. A model monitoring API 726 can access the model logs database 724 to support checks of model reasoning; the model monitoring API may be decoupled from the model monitoring, retraining and backtesting module 728 as shown, or may be integrated therewith. The model monitoring, retraining and backtesting module 728 enables regular tests of the efficacy of the first trained machine learning model 716 and the second trained machine learning model 720 using, for example, a random holdout method. By randomly selecting some subjects to undergo a rules-based evaluation or a human evaluation regardless of their eligibility for a first threshold assessment and/or a second threshold assessment, the trained machine learning models 716, 720 can run in parallel with rules-based evaluation and/or human evaluation. This dual approach enables outputs of the trained machine learning models 716, 720 to be compared to outputs of the rules-based evaluation and/or human evaluation, providing valuable feedback to identify any model drift. Model drift occurs when the statistical properties of the target variable change, leading to a decline in model performance. To detect model drift, the model's performance metrics (accuracy, precision, recall, F1 score) may be monitored on a periodic basis (e.g. weekly). In one embodiment, the KS 2-sample test may be used to compare the distribution of recent prediction outcomes with the distribution of training data predictions. Significant deviations detected by the KS test will indicate potential model drift.

When model drift is detected, retraining or model replacement can be considered. Additionally, the backtesting framework 728 facilitates baseline checks for any experimental changes, supporting continuous improvement and accuracy in the trained machine learning models 716, 720. Moreover, data gathered from subjects who underwent rules-based evaluation and/or human evaluation may be used to enhance performance of the trained machine learning models 716, 720 by incorporating novel insights.

Additionally, the backtesting framework 728 may implement a feedback loop based on observed results after approval (e.g. approval 410) to track the accuracy of the risk assessment. This allows the weighting of risk scores for each of the first trained machine learning model (e.g. first trained machine learning model 454), the second trained machine learning model (e.g. second trained machine learning model 458 or particular sub-models 458A . . . 458n thereof) and any subsequent trained machine learning models to be adjusted to learn from history to increase the threshold required for approval if the risk assessment proves to be too lax. Optionally, a rules engine test (e.g. rules engine test 452) may also be similarly adjusted.

The frontend 702 is preferably implemented using technologies and languages that revolve around an asynchronous flow and industry standard HTTPS requests. In one embodiment, the frontend is built on the Next.js 14 React framework (https://nextjs.org/) with Typescript (https://www.typescriptlang.org/).

The orchestration layer API 704, application submission API 710, rules engine API 712, model APIs 714, 718 and model monitoring API 726 may be implemented using the FastAPI framework (https://fastapi.tiangolo.com/) following a REST architecture.

The cache 706 may be implemented using Redis (https://redis.io/), and the user application database 708 and model logs database 724 may be implemented using PostgreSQL (https://www.postgresql.org/).

The first trained machine learning model (auto-approval model) 716 and the second trained machine learning model (impairment model) 720 may be implemented using mlflow (https://mlflow.org/). For example, one or more mlflow servers (on-premises, via cloud computing, or a combination) may host the first trained machine learning model 716 and the second trained machine learning model 720 and host or interface with the model monitoring, retraining and backtesting module 728 and the model logs database 724.

Python may be used in various aspects of the implementation.

As noted above, “path 1” 470 (FIG. 4A) represents evaluation by the first trained machine learning model (auto approval model) 716 based on only the demographic subject data 452. In “path 1” 470, the frontend 702 sends the demographic subject data 452 (FIG. 4A) to the first trained machine learning model (auto approval model) 716 which determines whether the subject can be approved at this stage. This occurs in the following steps, which includes a preliminary cache check before the first trained machine learning model (auto approval model) 716 is invoked:
1. First, the demographic subject data 452 is sent in a request to the cache 706, which stores model outputs (e.g. approval/denial for insurance) for previous subjects.
2. If the current subject has the same demographic subject data 452 as a previous subject, the model output for the previous subject (e.g. approval/denial for insurance) will be returned from the cache 706 as the model output for the current subject, thereby minimizing unnecessary processing.
3. If the demographic subject data 452 for the current subject has not been seen before (not in the cache 706), the frontend 702 sends a request to the orchestration layer API 704 to invoke the first trained machine learning model (auto approval model) 716 via the auto-approval model API 714.
4. If the first trained machine learning model (auto approval model) 716 indicates that the subject passes the first threshold assessment, the subject will be approved. If the subject fails the first threshold assessment, the subject proceeds to “path 2” 472 (FIG. 4A).

“Path 2” 472 (FIG. 4A) represents evaluation by the second trained machine learning model (impairment model) 720 based on both the demographic subject data 452 (FIG. 4A) and the supplemental context-related subject data 456, which includes salubriousness data (e.g. answers to lifestyle and basic medical questions). After the supplemental context-related subject data 456 (FIG. 4A) is obtained, the following steps are taken, again including a preliminary cache check before invoking the second trained machine learning model (impairment model) 720.

1. First, the demographic subject data 452 and the supplemental context-related subject data 456 is sent in a request to the cache 706.

2. If the current subject has the same demographic subject data 452 and supplemental context-related subject data 456 as a previous subject, the cache 706 returns the model output for the previous subject as the model output for the current subject.

3. If the demographic subject data 452 and the supplemental context-related subject data 456 for the current subject do not match a previous subject in the cache, the frontend 702 will send a request to the orchestration layer API 704 to invoke the second trained machine learning model (impairment model) 720 via the impairment model API 718. The request includes an indication of which of the impairment models 720A to 720D are to be invoked. The relevant impairment model(s) 720A to 720D will predict if the health condition of the subject is sufficiently under control.

4. If the relevant impairment model(s) 720A to 720D predict that the health condition(s) of the subject do not exceed the risk threshold, the subject is approved; otherwise, the subject will proceed to “path 3” 474 (FIG. 4A).

As can be seen from the above description, the management of computer resource use when conducting a computer-implemented risk assessment described herein represents significantly more than merely using categories to organize, store and transmit information and organizing information through mathematical correlations. The present technology deploys machine learning risk assessment, which proceeds in incremental stages so as to improve performance by avoiding the computational cost of obtaining and processing information that is ultimately unnecessary to perform the risk assessment. Using external public data, proprietary historical data and demographic information, models according to aspects of the present disclosure can predict risk factors in the absence of certain information, further improving processing. The technology is in fact an improvement to computer resource management in computerized risk assessment, because it allows for limited information gathering and relatively less resource-intensive processing to be deployed first, with further information gathering and relatively more resource-intensive processing being deployed only where the less resource-intensive processing cannot definitively resolve the risk assessment. As such, the computer resource use management technology is confined to computer-implemented risk assessment applications. Importantly, however, the present disclosure is not directed merely to the automation of a manual risk assessment process by generic computer processing of mathematical calculations, but describes specific functional computer technology that provides for more efficient use of computer resources than would be the case with conventional automation (i.e. automated risk assessment that omitted the sequentially phased information gathering and processing). Furthermore, the human mind is not equipped to apply machine learning models; these are activities that are unique to computers and by their very nature require computer implementation—they exist only in the context of a computer system. Thus, the present disclosure is directed to the resolution of a computer problem, specifically how to effectively balance the desire for efficient use of computer resources against the need for accurate processing by the computer system(s). By increasing the information gathering and processing only when lesser amounts of information gathering and processing are not dispositive for the risk assessment, a suitable balance may be achieved. In addition, by avoiding scenarios where online applications are commenced but are not completed, further potential squandering of computer resources on aborted applications may be avoided.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible, non-transitory device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A computer-implemented method for managing computer resource use when conducting a computer-implemented risk assessment of a subject in respect of a context, the method comprising:
receiving demographic subject data for the subject;
passing the demographic subject data to a first trained machine learning model, wherein the first trained machine learning model has been trained on first context-specific historical risk outcomes correlated with historical demographic data corresponding to the demographic subject data;
receiving a first threshold assessment from the first trained machine learning model;
responsive to passing the first threshold assessment, approving the subject;
responsive to failing the first threshold assessment:
receiving supplemental context-related subject data for the subject, wherein the supplemental context-related subject data is in addition to the demographic subject data;
passing the demographic subject data and the supplemental context-related subject data to a second trained machine learning model, wherein the second trained machine learning model has been trained on second context-specific historical risk outcomes correlated with the historical demographic data and with historical context-related data corresponding to the supplemental context-related subject data;
receiving a second threshold assessment from the second trained machine learning model; and
responsive to passing the second threshold assessment, approving the subject;
wherein, because receiving the supplemental context-related subject data for the subject, passing the demographic subject data and the supplemental context-related subject data to the second trained machine learning model and receiving the second threshold assessment from the second trained machine learning model occur only responsive to failing the first threshold assessment, use of computer resources associated with receiving the supplemental context-related subject data for the subject, passing the demographic subject data and the supplemental context-related subject data to the second trained machine learning model and receiving the second threshold assessment from the second trained machine learning mode is avoided where the subject passes the first threshold assessment test.

2. The method of claim 1, further comprising:
before passing the demographic subject data to the first trained machine learning model, applying a preliminary risk qualification test to the subject;
wherein passing the demographic subject data to the first trained machine learning model occurs only responsive to passing the preliminary risk qualification test; and
receiving the supplemental context-related subject data and passing the demographic subject data and the supplemental context-related subject data to the second trained machine learning model occurs responsive to either of:
failing the preliminary risk qualification test; or
failing the first threshold assessment;
wherein, because passing the demographic subject data to the first trained machine learning model occurs only responsive to passing the preliminary risk qualification test, additional use of computer resources associated with passing the demographic subject data to the first trained machine learning model and receiving the first threshold assessment from the first trained machine learning model is avoided where the subject fails the preliminary risk qualification test.

3. The method of claim 1, further comprising:
responsive to failing the second threshold assessment, undertaking further processing of the subject;
wherein, because the further processing of the subject is undertaken only responsive to failing the second threshold assessment, additional use of computer resources associated with the further processing of the subject is avoided where the subject passes the second threshold assessment.

4. The method of claim 1, further comprising:
responsive to failing the second threshold assessment:
receiving additional context-related subject data for the subject, wherein the additional context-related subject data is in addition to the demographic subject data and to the supplemental context-related subject data;
passing the demographic subject data, the supplemental context-related subject data and the additional context-related subject data to a third trained machine learning model, wherein the third trained machine learning model has been trained on third context-specific historical risk outcomes correlated with the historical demographic data, the historical context-related data, and additional historical context-related data corresponding to the additional context-related subject data;
receiving a third threshold assessment from the third trained machine learning model; and
responsive to passing the third threshold assessment, approving the subject;
wherein, because receiving the additional context-related subject data for the subject, passing the demographic subject data, the supplemental context-related subject data and the additional context-related subject data to the third trained machine learning model and receiving the third threshold assessment from the third trained machine learning model occur only responsive to failing the second threshold assessment, use of computer resources associated with receiving the additional context-related subject data for the subject, passing the demographic subject data, the supplemental context-related subject data and the additional context-related subject data to the third trained machine learning model and receiving the third threshold assessment from the third trained machine learning mode is avoided where the subject passes the second threshold assessment test.

5. The method of claim 1, wherein, wherein the first trained machine learning model is a first decision tree model.

6. The method of claim 5, wherein, wherein the first decision tree model is a random forest model.

7. The method of claim 6, wherein, wherein the second trained machine learning model is a second decision tree model.

8. The method of claim 7, wherein, wherein the second decision tree model is a random forest model.

9. The method of claim 1, further comprising returning a respective model interpretation explaining at least one of the first threshold assessment and the second threshold assessment.

10. The method of claim 1, wherein the subject is a human being.

11. The method of claim 1, wherein the subject is a non-human animal.

12. The method of claim 1, wherein the second trained machine learning model comprises a plurality of individual sub-models.

13. The method of claim 1, wherein:
the context requires health assessment;
the demographic subject data omits any explicit salubriousness data; and
the supplemental context-related subject data includes explicit salubriousness data.

14. The method of claim 13, wherein the context is protection.

15. A computer program product comprising at least one tangible, non-transitory computer readable medium embodying instructions which, when executed by at least one processor of a data processing system, cause the data processing system to implement the method of claim 1.

16. A data processing system comprising at least one processor and memory coupled to the at least one processor, wherein the memory contains instructions which, when executed by the at least one processor, cause the data processing system to implement the method of claim 1.

17. A computer-implemented method for managing computer resource use when conducting a risk assessment of a subject in respect of a context, the method comprising:
receiving demographic subject data for the subject;
applying a preliminary risk qualification test to the subject;
responsive to passing the preliminary risk qualification test, passing the demographic subject data to a first trained machine learning model, wherein the first trained machine learning model has been trained on first context-specific historical risk outcomes correlated with historical demographic data corresponding to the demographic subject data;
receiving a first threshold assessment from the first trained machine learning model;
responsive to passing the first threshold assessment, approving the subject;
responsive to failing the preliminary risk qualification test or to failing the first threshold assessment:
receiving supplemental context-related subject data for the subject, wherein the supplemental context-related subject data is in addition to the demographic subject data;
passing the demographic subject data and the supplemental context-related subject data to a second trained machine learning model, wherein the second trained machine learning model has been trained on second context-specific historical risk outcomes correlated with the historical demographic data and with historical context-related data corresponding to the supplemental context-related subject data;
receiving a second threshold assessment from the second trained machine learning model;
responsive to passing the second threshold assessment, approving the subject;
wherein, because receiving the supplemental context-related subject data for the subject, passing the demographic subject data and the supplemental context-related subject data to the second trained machine learning model and receiving the second threshold assessment from the second trained machine learning model occurs only responsive to failing the preliminary risk qualification test or to failing the first threshold assessment, computer resource use associated with receiving the supplemental context-related subject data for the subject, passing the demographic subject data and the supplemental context-related subject data to the second trained machine learning model and receiving the second threshold assessment from the second trained machine learning model is avoided where the subject passes the preliminary risk qualification test or passes the first threshold assessment.

18. The method of claim 17, wherein:
the context requires health assessment;
the demographic subject data omits any explicit salubriousness data; and
the supplemental context-related subject data includes explicit salubriousness data.

19. A computer program product comprising at least one tangible, non-transitory computer readable medium embodying instructions which, when executed by at least one processor of a data processing system, cause the data processing system to implement the method of claim 17.

20. A data processing system comprising at least one processor and memory coupled to the at least one processor, wherein the memory contains instructions which, when executed by the at least one processor, cause the data processing system to implement the method of claim 17.
